(19) United States
(12) Patent Application Publication
(10) Pub. No.: US 2013/0176921 A1
(43) Pub. Date: Jul. 11, 2013

(54) VHT TXOP POWER SAVE

(71) Applicants: Liwen Chu, San Ramon, CA (US); George A. Vlantis, Sunnyvale, CA (US)

(72) Inventors: Liwen Chu, San Ramon, CA (US); George A. Vlantis, Sunnyvale, CA (US)

(73) Assignee: STMicroelectronics, Inc., Coppell, TX (US)

(21) Appl. No.: 13/344,351

(22) Filed: Jan. 5, 2012

(51) Int. Cl. H04W 52/02

(52) U.S. Cl. 370/311

(57) ABSTRACT

A wireless, specifically VHT, system that includes APs and STAs can power save during the TXOP. The AP in the system announces whether STAs in the system do SU or MU TXOP power save in a Beacon/Probe Response, and the STAs in the system transmit to the AP whether the STA is capable and willing to save power during a SU, MU, or SU+MU TXOP. For the AP, the process further involves buffering data frames for STAs that have entered doze mode until the end of TXOP. The AP further transmits to STAs a duration of TXOP in the Duration field of a RTS frame. The STA can inform the AP to enter TXOP PM mode in a bit in the HT Control field.

### BACKGROUND OF THE INVENTION

1. Field of the Invention

The present invention relates, in general, to power saving in a wireless system, and, more particularly, to power saving during a transmit opportunity (TXOP) for very high throughput (VHT) or other wireless devices.

2. Relevant Background

There is a further need to save power for wireless and VHT devices.

### SUMMARY OF THE INVENTION

Briefly stated, the present invention involves controlling an awake or doze state of wireless and VHT devices during the TXOP.

According to an embodiment of the invention, a method of power saving for an access point (AP) comprises deciding if power saving is allowed in a TXOP with any combination of DL MU-MIMO and SU-MIMO transmission, and if yes, sending buffered frames indicating TXOP power saving in the TXOP to stations that are not in doze state, and checking if there is no further buffered frames to the first station (STA) that is not in doze state, and if yes, sending buffered frames to a first station (STA) in a first remaining TXOP by setting “More Data” to ‘0’ in a frame to the first STA that is not in doze state, and sending buffered frames to a second STA that is not in doze state in a second remaining TXOP.

According to another embodiment of the invention, a method of power saving for a non-AP STA comprises checking if a specific TXOP power saving indicating bit in a received frame or PPDU is set such that STAs can do power save during the specific TXOP and going to doze state until the end of the specific TXOP if the STA is not a destination of frames.

According to another embodiment of the invention, a method of power saving for a non-AP STA comprises checking if a bit in a received frame or PPDU is set such that STAs can do power save during a TXOP and going to doze state until the end of the TXOP if the STA is a destination of frames and there is no more buffered frames with it as the destination.

According to a further embodiment of the invention, a method of power save for a wireless system comprises, for an AP in the system, announcing whether STAs in the system can do a single user (SU) or multiple user (MU) TXOP power save in a Beacon/Probe Response and for a STA in the system, transmitting to the AP whether the STA is capable and willing to save power during a TXOP with any combination of DL MU-MIMO and SU-MIMO transmission.

### BRIEF DESCRIPTION OF THE DRAWINGS

FIG. 1 shows an example of multi-user multiple input and multiple input output (MU-MIMIO) TXOP power save;

FIG. 2 shows an example of SU-MIMIO TXOP power save according to an embodiment of the invention;

FIG. 3 shows a method of VHT TXOP power saving for APs according to an embodiment of the invention; and

FIG. 4 shows a method of VHT TXOP power saving for non-AP STAs according to an embodiment of the invention.

### DETAILED DESCRIPTION OF THE PREFERRED EMBODIMENTS

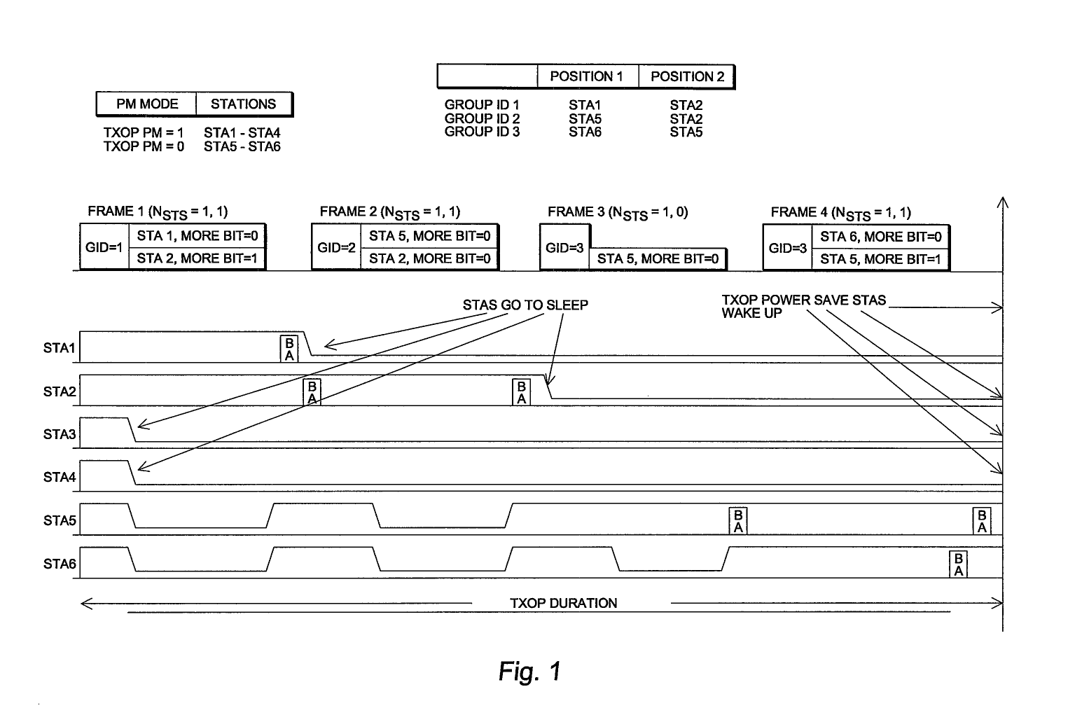

FIG. 1 shows an example of MU-MIMIO TXOP power save in the related art.

During down link (DL) MU TXOP for power save, DL MU-MIMO PW (power save) capable STAs can save power by the following activities: DL MU-MIMO TXOP PW STAs that are not members of a Group ID received in VHT-signal (SIG)-A can save power from the beginning until the end of the DL MU TXOP; DL MU-MIMO TXOP PW STAs that are members of a Group ID received in VHT-signal (SIG)-A can further save power after receiving a frame with NSTS=0 corresponding to it until the end of the DL MU TXOP; and DL MU-MIMO TXOP PW STAs that are members of a Group ID received in VHT-signal (SIG)-A can still further save power after sending a block acknowledgement (BA) for the frame with “More Data” bit=0.

An AP needs to announce whether or not it allows STAs to do DL MU TXOP power save in Beacon/Probe Response; the “VHT TXOP PS” field, where PS is power save, transmitted by the AP is used for this purpose. However, the AP also needs to know whether a STA is capable and willing to save power during a DL MU-MIMO TXOP. A TXOP Power Management mode is defined in the “VHT TXOP PS” field transmitted by a STA for this purpose. The AP needs to buffer data frames for a STA that has entered doze mode until the end of the DL MU-MIMO TXOP.

The AP needs to indicate whether or not DL MU-MIMO TXOP PW STAs can power save during the DL MU TXOP. TXOP_PS_NOT_ALLOWED is used for this indication. A STA that is in TXOP PS mode also needs to know the DL MU-MIMO TXOP duration. This can be done by checking the Duration field of the RTS/CTS frames, by requiring Request to Send/Clear to Send (RTS/CTS) exchange at the beginning of a DL MU-MIMO TXOP.

The “More Data” bit in the frame control field and the N_{sTS} field in VHT-SIG-A are used to indicate whether data frames are pending in the AP for transmission. More Data=0 indicates no more data frames are to be transmitted to this STA until the end of this TXOP. N_{STS}=0 indicates no data frames will be transmitted to this STA until the end of this TXOP.

Referring to the MU-MIMIO TXOP power save example in FIG. 1, STA1-STA4 are in TXOP PM (power save mode)=1 mode, indicating that STA1-STA4 are willing and capable of power save, and STA5 and STA6 are in TXOP PM=0 mode, indicating STA5 and STA6 are either unwilling or not capable of power save. The STAs are in various groups: Group ID 1 has STA1 and STA2; Group ID 2 has STA5 and STA2; Group ID 3 has STA6 and STA5.

During frame 1 of a TXOP duration, frame 1 is used by Group ID 1 (GID=1). Therefore, only STA1 and STA2 will transmit or receive during this period, and STA3-STA6 are idle. Since STA3 and STA4 can do DL MU-MIMO TXOP power save and frame 1 does not involve them, they will go to sleep. STA1 has More Bit=0, indicating there are no more data frames pending for STA1 during the TXOP duration, and STA1 can go to sleep after sending acknowledge of frame 1. STA2 has More Bit=1, indicating there are more data frames pending for STA2 during the TXOP duration, so STA2 remains active.

Frame 2 is used by Group ID 2 (GID=2). The More Bit=0 for STA2, indicating there are no more data frames pending for STA2 during the TXOP duration. STA2 can go to sleep after sending acknowledge of frame 2. The More Bit does not matter for STA5 as STA5 cannot power save.

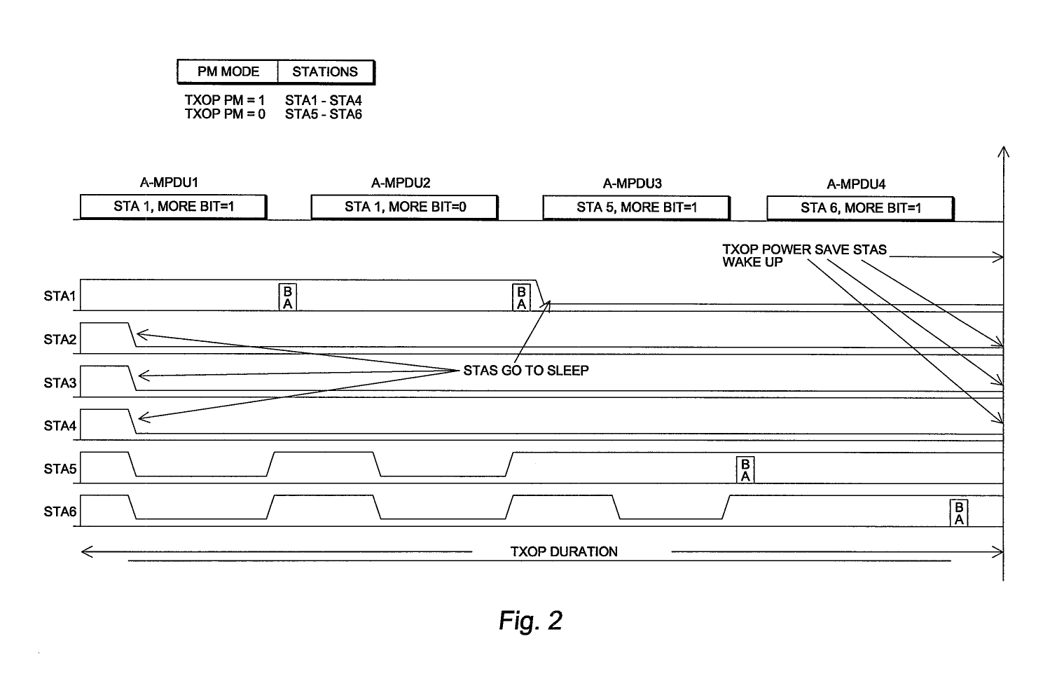

Frame 3 is used by STA5 only as N_{STS}=1,0 (N_{STS} for STA5 is not 0, N_{STS} for STA6 is 0) for Group ID 3 (GID=3). Frame is used by both STA5 and STA6 as N_{STS}=1,1 (N_{STS} for STA5 is not 0, N_{STS} for STA6 is not 0) for Group ID 3. After frame 4, the TXOP duration ends and all TXOP power save STAs, STA1-STA4, wake up. FIG. 2 shows an example of SU-MIMIO TXOP power save according to an embodiment of the invention.

The issue with DL MU-MIMO TXOP power save is that it can only be used in DL MU-MIMO TXOP. In a VHT TXOP, MU-MIMO is an optional feature. Non-MU-MIMO basic service sets (BSSs) cannot benefit from a MU-MIMO TXOP power save. DL MU-MIMO is more complicated than SU MIMO TXOP so VHT STAs may not implement DL MU-MIMO even in a MU-MIMO BSS. When a TXOP is used for SU MIMO and/or MU-MIMO, a STA cannot go to doze until the end of the TXOP. As SU-MIMO is a mandatory feature, more BSSs will benefit from a TXOP power save feature by allowing SU MIMO TXOP power saving. To implement SU MIMO TXOP power saving, DL MU-MIMO TXOP PW signaling needs to be extended. An AP needs to announce whether or not it allows STAs to do TXOP power save in a TXOP with any combination of DL MU-MIMO and SU MIMO transmission in Beacon/Probe Response frame. However, the AP also needs to know whether a STA is capable and willing to save power during a TXOP with any combination of DL MU-MIMO and SU MIMO transmission. The AP needs to buffer data frames for a STA that has entered doze mode until the end of the TXOP with any combination of DL MU-MIMO and SU MIMO transmission.

Further, in a proposed enhanced TXOP power save, the “More Data” bit in the frame control field can be used to indicate whether data frames are pending in the AP for DL MU-MIMO and/or SU MIMO transmission. More Data=0 indicates no more data frames are to be transmitted to this STA until the end of this TXOP with any combination of DL MU-MIMO and SU MIMO transmission. Further, the N_{STS} field in VHT-SIG-A of MU-MIMO PPDU can be used to indicate whether data frames are pending in the AP for transmission. N_{STS}=0 indicates no data frames will be transmitted to this MU-MIMO capable STA until the end of this TXOP with any combination of DL MU-MIMO and SU MIMO transmission.

Referring to the SU-MIMO TXOP power save example in FIG. 2, according to an embodiment of the invention, STA1-STA4 are in TXOP PM=1 mode, indicating STA1-STA4 are willing and capable of power save, and STA5-STA6 are in TXOP PM=0 mode, indicating STA5-STA6 are either unwilling or not capable of power save.

In aggregated media access control protocol data unit 1 (A-MPDU1), STA1 has More Bit=1 so STA1 remains active after sending acknowledge of A-MPDU1. When STA2-STA4 receive A-MPDU1, they can realize that the A-MPDU1 does not involve them. Since STA2-STA4 are TXOP PM STAs and the AP allows TXOP power saving in the TXOP, STA2-STA4 can go to sleep until the end of the TXOP. STA5-STA6 do not go to sleep since they are active STAs.

In A-MPDU2, STA1 has More Bit=0 so STA1 goes to sleep after sending acknowledge of A-MPDU2, since STA1 is TXOP PM STA and the AP will not transmit further frames to it during the remaining TXOP. Similar to A-MPDU1, STA5-STA6 do not go to sleep since they are active STAs. A-MPDU3 and A-MPDU4 relates to STA5 and STA6. STA1-STA4 wakes up at the end of the TXOP duration.

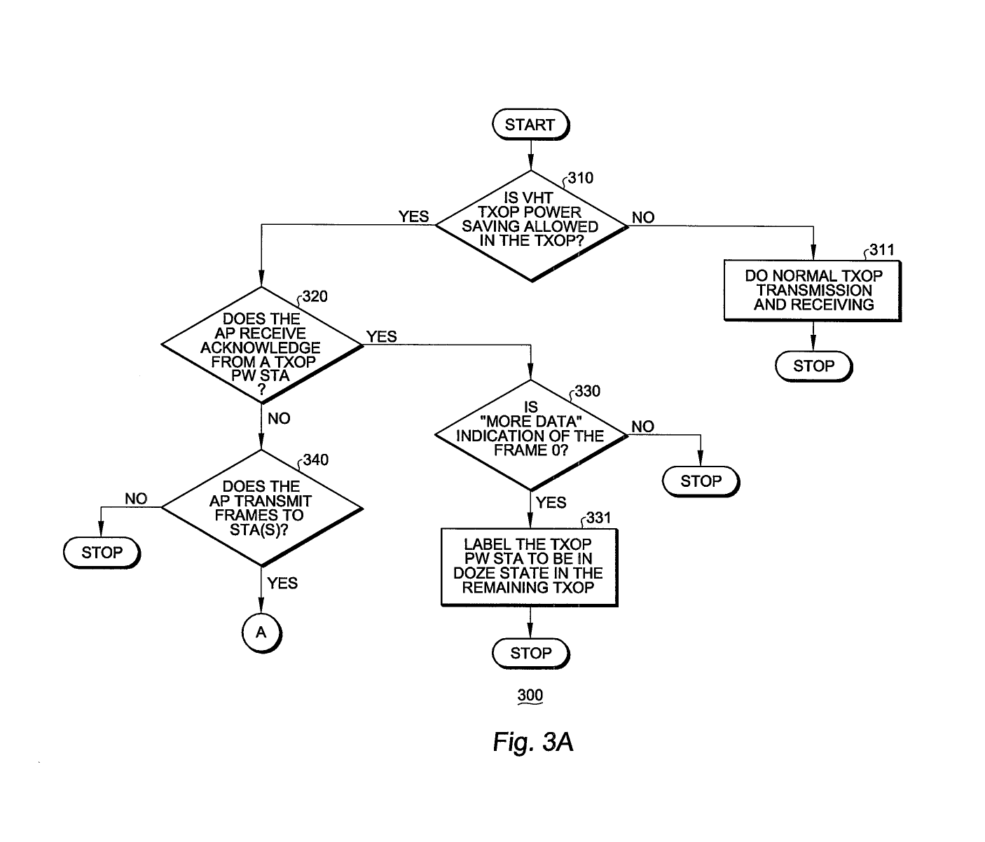

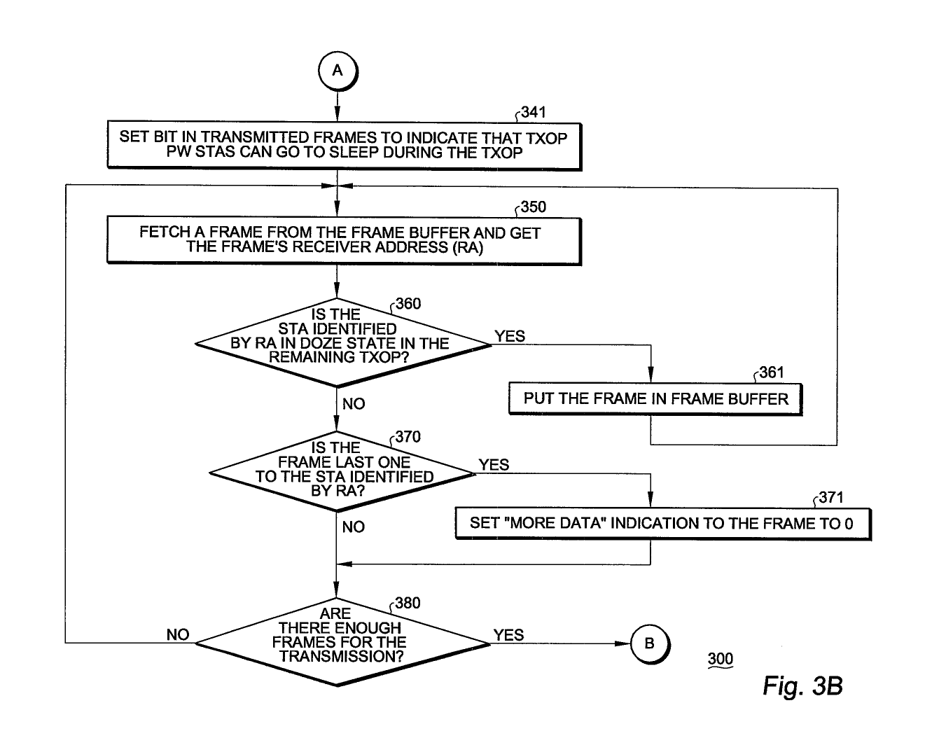

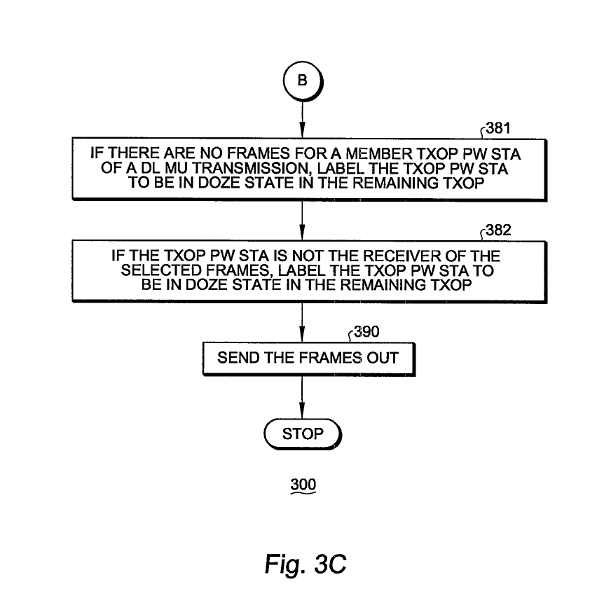

FIG. 3 shows a method of VHT TXOP power saving for APs according to an embodiment of the invention.

In the related art, TXOP power save capable VHT STA during TXOP for power save can save power by the following. If a VHT TXOP PW STA that implements DL MU-MIMO is not a member of the Group of the received A-MPDU as indicated in VHT-SIG-A, it can save power enduring the remaining TXOP. The STA that implements DL MU-MIMO saves power after receiving a frame with NSTS=0 corresponding to it until the end of DL MU TXOP. The VHT TXOP PW STA saves power after sending the BA for the frame with “More Data” bit=0.

According to an embodiment of the invention, TXOP power save capable VHT STA during TXOP for power save can save power by the following activity. If a VHT TXOP PW STA that implements SU MIMO and/or DL MU-MIMO is not a member of the Group of the received A-MPDU as indicated in VHT-SIG-A, it can save power during the remaining TXOP. A VHT TXOP PW STA that is not the destination of the SU-MIMO frame saves power during the remaining TXOP; if Partial AID in the PHY header of the receiving PPDU (PLCP protocol data unit) is not same as a STA's Partial AID, the STA is not the destination of the MPDU(s) of the PPDU; if the Partial AID in the PHY header is the same as a STA's Partial AID but the RA is not the same as STA's MAC address, the STA is not the destination of the MPDU(s) of the PPDU. The VHT TXOP PW STA that implements SU MIMO and/or DL MU-MIMO saves power after receiving a frame with N_{STS}=0 corresponding to it until the end of DL MU TXOP. The VHT TXOP PW STA saves power after sending the acknowledge for the frame with “More Data” bit=0.

The AP needs to announce whether or not it allows STAs to do (SU and MU) TXOP power save in Beacon/Probe Response; the “VHT TXOP PS” field in VHT Capabilities IE (Information Element) transmitted by the AP is used for this purpose. Additionally, to give an AP more flexible design, e.g., for buffer management, an AP can select if TXOP power saving is allowed in each individual TXOP with any combination of DL MU-MIMO and SU-MIMO transmission. Therefore, the AP needs to indicate whether or not VHT STAs can be in a doze state during the TXOP with any combination of DL MU-MIMO and SU-MIMO transmission. TXOP_PS_NOT_ALLOWED in PHY header is used for this indication. A STA that is in TXOP PS mode needs to know the TXOP duration. This is done by checking the Duration field of the RTS/CTS frames, and requires RTS/CTS exchange at the beginning of a TXOP with any combination of DL MU-MIMO and SU-MIMO transmission.

Also, the AP needs to know whether a STA is capable and willing to save power during a TXOP with any combination of DL MU-MIMO and SU MIMO transmission. A TXOP Power Management mode is defined for a STA. One bit “VHT TXOP PS” field in the VHT capabilities IE transmitted by STA can be used. A STA use “VHT TXOP PS” to inform the AP to enter TXOP PM mode. The AP needs to buffer data frames for a STA that has entered doze mode until the end of the TXOP.

Referring to FIG. 3, the VHT TXOP power saving algorithm for APs 300 starts with checking if VHT TXOP power saving is allowed in the TXOP 310. If no, normal TXOP transmission is performed 311 and process 300 terminates thereafter. If yes, the process checks if an acknowledge frame is received from an STA 320. If yes, the process checks if “More Data” is set to 0 in the acknowledged frame 330. If yes, the process labels the STA being in doze state in the remaining TXOP 331 then stops; if no, process 300 stops.

If the process gets no in 320, the process checks if there are frame(s) to send 340. If no, process 300 stops. If yes, a bit in transmitted frames is set to indicate that TXOP PW STAs can go to sleep during the TXOP 341. Then the process fetches a frame from its buffer and obtains the frame's receiver address (RA) 350. Then the process checks if the STA identified by RA is in doze state in the remaining TXOP 360. If yes, the process puts the frame to the buffer 361, then fetches a frame from its buffer and get the frame's receiver address (RA) 350. If no, the process checks if the frame is the last one to the STA identified by RA 370. If yes, the process sets “More Data” indication of the frame to 0 371. The process then checks if there are enough frames for the transmission 380. If no, the process fetches a frame from its buffer and gets the frame's receiver address (RA) 350. If yes, the process labels the TXOP PW STA as a member of a DL MU transmission to be in doze state in the remaining TXOP if there are no frames for it 381. Then the process labels the TXOP PW STA to be in doze state in the remaining TXOP if the STA is not the receiver of the selected frames 382. The process sends the frames out 391, and process 300 terminates.

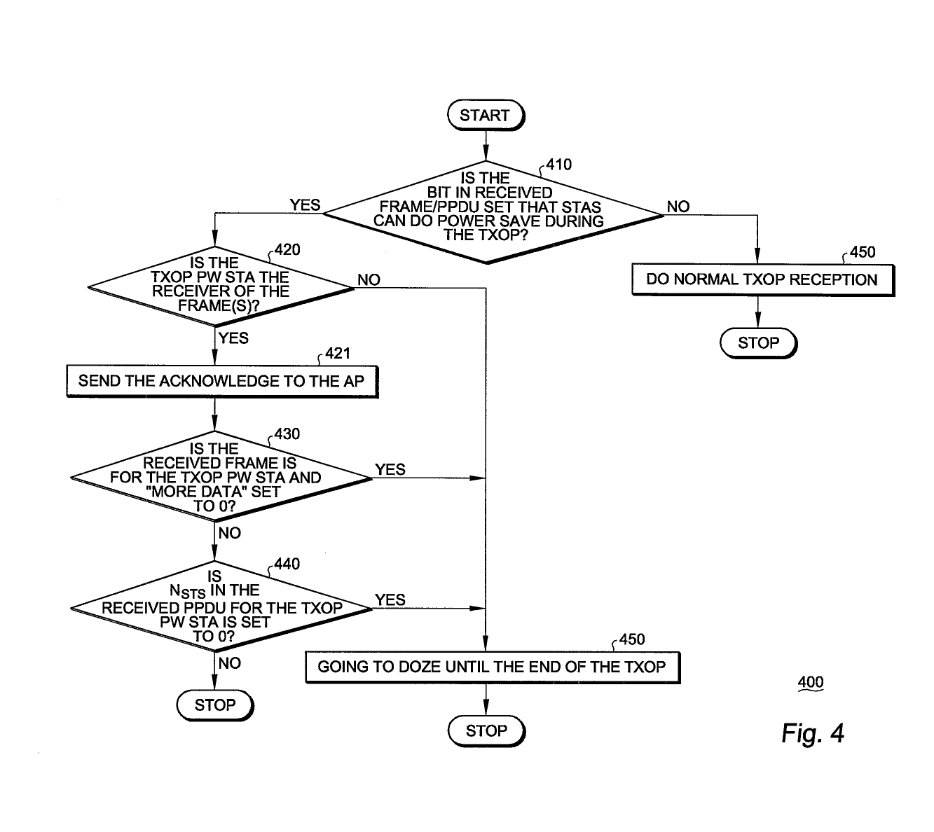

FIG. 4 shows a method of VHT TXOP power saving for non-AP STAs according to an embodiment of the invention.

Referring to FIG. 4, a VHT TXOP power saving algorithm for non-APs 400 starts with checking if a bit in received frame/PPDU is set such that STAs can do a power save during the TXOP 410. If no, normal TXOP reception is performed 450 and process 400 terminates. If yes, the process checks if the TXOP PW STA is the destination (receiver) of the frame(s) 420. If no, the process goes to a doze state until the end of the TXOP 450. If yes, the process sends acknowledge to the AP 421 then checks if the received frame is for the TXOP PW STA and “More Data” is set to ‘0’ 430. If yes, the process goes to a doze state until the end of the TXOP 450. If no, check if N_{STS} in the received PPDU for the TXOP PW STA is set to ‘0’ 440. If yes, the process goes to a doze state until the end of the TXOP 450. If no, the process stops.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of power saving, comprising:
in an AP, indicating if TXOP power saving is allowed in a TXOP;
in the AP, indicating if there are no further frames for a STA and deciding if the STA is in doze state in a remainder of the TXOP; and
in STA, deciding if the STA can go to doze state after receiving the indication from the AP.

2. The method of claim 1, wherein the TXOP comprises any combination of DL MU-MIMO and SU-MIMO transmissions.

3. The method of claim 1, wherein the indication is a frame/PPDU.

4. A method of power saving for an access point (AP), comprising:
indicating if the AP allows STAs to do TXOP power save in a TXOP in a Beacon and Probe Response frame;
indicating in the TXOP if the TXOP allows STAs to go to doze state in a remainder of the TXOP; and
doing TXOP power saving in the TXOP if the TXOP allows power save.

5. The method of claim , wherein the TXOP comprises any combination of DL MU-MIMO and SU-MIMO transmissions.

6. The method of claim 4, further comprising using a “VHT TXOP PS” field in VHT Capabilities IE (Information Element) to indicate if the AP allows STAs to do TXOP power save in the TXOP.

7. The method of claim , further comprising using TXOP_PS_NOT_ALLOWED in a PHY header to indicate if the AP allows STAs to go to doze state in the TXOP.

8. The method of claim , further comprising;
checking if power saving is allowed in the TXOP;
if yes, indicating a TXOP duration where TXOP PW is allowed in RTS and CTS frames;
labeling STAs in doze state in the remainder of the TXOP; and
avoiding transmitting frames to STAs in doze state in the remainder of the TXOP.

9. The method of claim 8, further comprising sending the frames out.

10. The method of claim 8, further comprising labeling a TXOP PW STA to be in doze state in remainder of the TXOP, wherein
the TXOP PW STA is not a receiver of a PPDU/frame transmitted by the AP.

11. The method of claim 8, further comprising deciding an STA is not a receiver of a PPDU/frame transmitted by the in the remainder of the TXOP, wherein
a Partial AID of the STA is not same as a Partial AID in a PHY header of a receiving SU PPDU (PLCP protocol data unit), or
a MAC address of the STA is not same as an RA of a MAC header in SU PPDU, or
the STA is not a member of a receiver of a MU PPDU, or
the STA is a member of a receiver of the MU PPDU and the MU PPDU.

12. The method of claim 8, further comprising labeling a TXOP PW STA to be in doze state in the remainder of the TXOP, wherein
the TXOP PW STA responds acknowledge to frames which are last frames to the TXOP PW STA.

13. The method of claim 8, further comprising buffering frames to doze STAs in the remainder of the TXOP when the AP receives frames for the doze STAs from an upper layer or other STAs.

14. The method of claim 8, further comprising if power saving is not allowed in the TXOP, performing normal TXOP transmission.

15. The method of power saving for an STA, comprising:
indicating if the STA is capable and willing to save power during a TXOP; and
doing TXOP power saving in the TXOP that allows TXOP power save.

16. The method of claim 15, wherein the TXOP comprises any combination of DL MU-MIMO and SU MIMO transmissions.

17. The method of claim 15, further comprising using a “VHT TXOP PS” field in a VHT Capabilities IE (Information Element) to indicate if the STA is capable and willing to save power during a TXOP.

18. The method of claim 15, further comprising:
checking if power saving is allowed in a transmit opportunity (TXOP);
if yes, acquiring a TXOP duration where TXOP PW is allowed in received RTS and CTS frames; and
going to doze state in a remainder of the TXOP.

19. The method of claim 18, further comprising deciding that the STA can go to doze state in the remaining TXOP, wherein
a Partial AID of the STA is not same as a Partial AID in a PHY header of a receiving SU PPDU (PLCP protocol data unit), or
a MAC address of the STA is not same as RA of MAC header in SU PPDU, or
the STA is not a member of a receiver of a MU PPDU, or
the STA is a member of a receiver of MU PPDU and the MU PPDU has no A-MPDU for the STA.

20. The method of claim 18, further comprising deciding that the STA can go to doze state in the remainder of the TXOP, wherein
the STA is a TXOP PW STA and receives frames which are last frames to the STA and sends acknowledge to an AP.

21. The method of claim 8, further comprising if power saving is not allowed in the TXOP, performing normal TXOP transmission.
